(19) United States
(12) Patent Application Publication
(10) Pub. No.: US 2015/0177871 A1
(43) Pub. Date: Jun. 25, 2015

(54) TOUCH PANEL, MANUFACTURING METHOD THEREOF, AND TOUCHSCREEN APPARATUS

(71) Applicant: SAMSUNG ELECTRO-MECHANICS CO., LTD., Suwon (KR)

(72) Inventors: Youn Soo KIM, Suwon (KR); Young Seuck YOO, Suwon (KR); Hyun Dong LEE, Suwon (KR); Sung HAN, Suwon (KR); Seung Min LEE, Suwon (KR); Seung Joo SHIN, Suwon (KR); Jae Ho SHIN, Suwon (KR)

(73) Assignee: SAMSUNG ELECTRO-MECHANICS CO., LTD., Suwon (KR)

(21) Appl. No.: 14/185,461

(22) Filed: Feb. 20, 2014

(30) Foreign Application Priority Data
Dec. 23, 2013 (KR) 10-2013-0161320

(51) Int. Cl. G06F 3/044

(52) U.S. Cl. CPC G06F 3/044; G06F 2203/04103

(57) ABSTRACT

There are provided a touch panel, a manufacturing method thereof, and a touchscreen apparatus. A touch panel according to an exemplary embodiment of the present disclosure includes: a substrate; a plurality of electrodes formed on an upper surface of the substrate and including conductive lines having a mesh form; and anti-reflective layers formed on upper surfaces of the conductive lines and voids of the substrate, wherein the anti-reflective layer formed on the upper surfaces of the conductive lines has a refractive index different from that of the anti-reflective layer formed on the voids of the substrate.

### CROSS-REFERENCE TO RELATED APPLICATION

This application claims the benefit of Korean Patent Application No. 10-2013-0161320 filed on Dec. 23, 2013, with the Korean Intellectual Property Office, the disclosure of which is incorporated herein by reference.

### BACKGROUND

The present disclosure relates to a touch panel, a manufacturing method thereof, and a touchscreen apparatus.

Recently, touch sensing apparatuses such as touchscreens, touch pads, and the like, apparatuses attached to display devices to provide users with an intuitive method of data input, have been widely applied to various electronic devices such as cellular phones, personal digital assistants (PDA), navigation devices, and the like. Particularly, as demand for smartphones has recently increased, the use of a touchscreens allowing for a variety of data inputs to be made in a limited form factor has increased.

Touchscreens commonly used in portable devices may mainly be divided into resistive type touchscreens and capacitive type touchscreens, according to a method of sensing a touch utilized therein. Here, capacitive type touchscreens have the advantages of a relatively long lifespan as well as allowing for various input methods and gestures to be easily implemented therewith, such that the use thereof has increased. Particularly, since capacitive type touchscreens may easily allow for the implementation of a multi-touch interface, as compared with resistive type touchscreens, such touchscreens are widely used in devices such as smartphones, and the like.

Capacitive type touchscreens commonly include a plurality of electrodes having a predetermined pattern and defining a plurality of nodes in which changes in capacitance are generated by a touch. In the plurality of nodes distributed on a two-dimensional plane, changes in self-capacitance or in mutual-capacitance are generated by touches. Coordinates of such touches may be calculated by applying a weighted average calculating method, or the like, to changes in capacitance generated in the plurality of nodes.

In a touch panel according to the related art, a sensing electrode recognizing a touch is generally formed of indium tin oxide (ITO). However, ITO is a relatively expensive material having a low degree of competitiveness, since indium used as a raw material in the manufacturing thereof is a rare earth element. In addition, world indium reserves are expected to be significantly depleted within the next decade, such that steady and continued supply of indium may not be guaranteed. Therefore, research into technology for forming electrodes using non-transparent metallic fine lines for the above-mentioned reasons has been undertaken. Here, the electrodes formed of the metallic fine lines may have improved conductivity as compared to those formed of ITO or a conductive polymer and the balance of supply and demand thereof may be kept. However, in the case in which the metallic fine lines are used as electrodes for touchscreens, light reflections caused by the color of the metal may occur, such that a user may readily recognize the metallic fine lines.

### RELATED ART DOCUMENT

(Patent Document 1) Korean Patent Laid-Open Publication No. 10-2011-0089423

### SUMMARY

An aspect of the present disclosure may provide a touch panel capable of allowing metallic lines of electrodes to be not apparently visible by forming anti-reflective layers having different refractive indices on fine conductive lines provided on a substrate and in voids of the substrate, a manufacturing method thereof, and a touchscreen apparatus.

According to an aspect of the present disclosure, a touch panel may include: a substrate; a plurality of electrodes formed on an upper surface of the substrate and including conductive lines having a mesh form; and anti-reflective layers formed on upper surfaces of the conductive lines and voids of the substrate, wherein the anti-reflective layer formed on the upper surfaces of the conductive lines has a refractive index different from that of the anti-reflective layer formed on the voids of the substrate.

The anti-reflective layers may include: a first anti-reflective layer formed on the upper surfaces of the conductive lines; and a second anti-reflective layer formed on the voids of the substrate.

A refractive index of the first anti-reflective layer may be higher than 1.6 and a refractive index of the second anti-reflective layer may be equal to or lower than 1.6.

A sum of a thickness of the conductive line and a thickness of the first anti-reflective layer may be equal to a thickness of the second anti-reflective layer.

The anti-reflective layers may be formed of a transparent resin having a predetermined photo-initiator added thereto.

The first anti-reflective layer may be formed of a photo resist having a predetermined photo-initiator added thereto.

The conductive lines may be formed of any one of silver (Ag), aluminum (Al), chrome (Cr), nickel (Ni), molybdenum (Mo), and copper (Cu) or an alloy of at least two of silver (Ag), aluminum (Al), chrome (Cr), nickel (Ni), molybdenum (Mo), and copper (Cu).

According to another aspect of the present disclosure, a method of manufacturing a touch panel may include: forming a metal film on one surface of a substrate; coating a photo resist having a photo-initiator added thereto on the metal film; forming a mask pattern by removing a predetermined region of the photo resist; forming conductive lines having a mesh form by etching the metal film using the mask pattern; and printing a transparent resin having a photo-initiator added thereto on voids of the substrate.

The photo resist may have a refractive index higher than 1.6 and an anti-reflective layer of the transparent resin may have a refractive index equal to or lower than 1.6.

The metal film may be formed of any one of silver (Ag), aluminum (Al), chrome (Cr), nickel (Ni), molybdenum (Mo), and copper (Cu) or an alloy of at least two of silver (Ag), aluminum (Al), chrome (Cr), nickel (Ni), molybdenum (Mo), and copper (Cu).

The transparent resin may be printed by a screen printing process.

According to another aspect of the present disclosure, a touchscreen apparatus may include: a panel unit including a substrate, a plurality of electrodes formed on an upper surface of the substrate and including conductive lines having a mesh form, and anti-reflective layers formed on upper surfaces of the conductive lines and voids of the substrate; and a controlling unit determining a touch by applying a predetermined driving signal to a portion of the plurality of electrodes and detecting capacitance from the remaining electrodes among the plurality of electrodes, wherein the anti-reflective layer formed on the upper surfaces of the conductive lines has a refractive index different from that of the anti-reflective layer formed on the voids of the substrate.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating an exterior appearance of an electronic device including a touchscreen apparatus according to an exemplary embodiment of the present disclosure;

FIG. 2 is a view illustrating a touch panel applicable to a touchscreen apparatus according to an exemplary embodiment of the present disclosure;

FIGS. 3 and 4 are views illustrating a touch panel according to the exemplary embodiment of FIG. 2;

FIG. 5 is a cross-sectional view of the touch panel shown in FIGS. 2 through 4;

FIG. 6 is a view illustrating a touchscreen apparatus according to an exemplary embodiment of the present disclosure; and

FIG. 7 is a cross-sectional view illustrating a touch panel according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

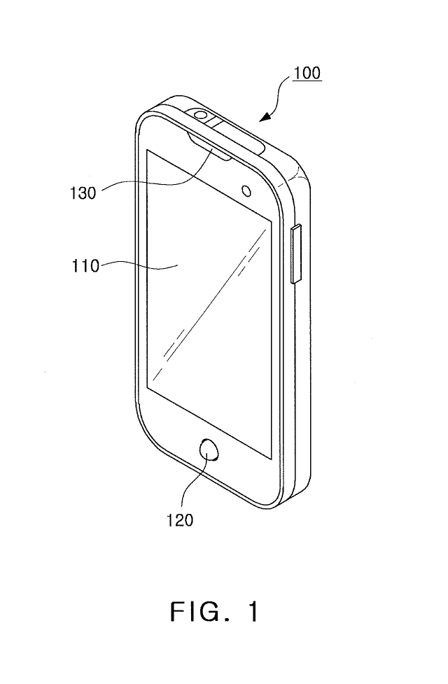

FIG. 1 is a perspective view illustrating an exterior appearance of an electronic device including a touchscreen apparatus according to an exemplary embodiment of the present disclosure.

Referring to FIG. 1, an electronic device 100 according to an exemplary embodiment of the present disclosure may include a display device 110 for displaying an image, an input unit 120, an audio unit 130 for audio output, and a touch sensing apparatus integrated with the display device 110.

As shown in FIG. 1, in a case of a mobile device, the touchscreen apparatus may be generally provided to be integrated with the display device and is required to have a degree of light transmissivity sufficient to allow an image displayed on the display device to be transmitted therethrough. Therefore, the touchscreen apparatus may be obtained by forming electrodes made of a material having conductivity on a film made of a material such as polyethylene terephtalate (PET), polycarbonate (PC), polyethersulfone (PES), polyimide (PI), polymethylmethacrylate (PMMA), cyclo-olefin polymers (COP), or the like, and a transparent substrate made of a material such as soda glass or tempered glass. The display device may include a wiring pattern disposed in a bezel region thereof, in which the wiring pattern is connected to the electrode formed of an electro-conductive material and is visually shielded by the bezel region.

Since it is assumed that the touchscreen apparatus according to the exemplary embodiment of the present disclosure is a capacitive type touchscreen, the touchscreen apparatus may include a plurality of electrodes having a predetermined pattern. In addition, the touchscreen apparatus may include a capacitance sensing circuit for detecting changes in capacitance generated in the plurality of electrodes, an analog to digital converting circuit for converting a signal output by the capacitance sensing circuit to a digital value, an operating circuit for determining a touch using data converted to the digital value, and the like.

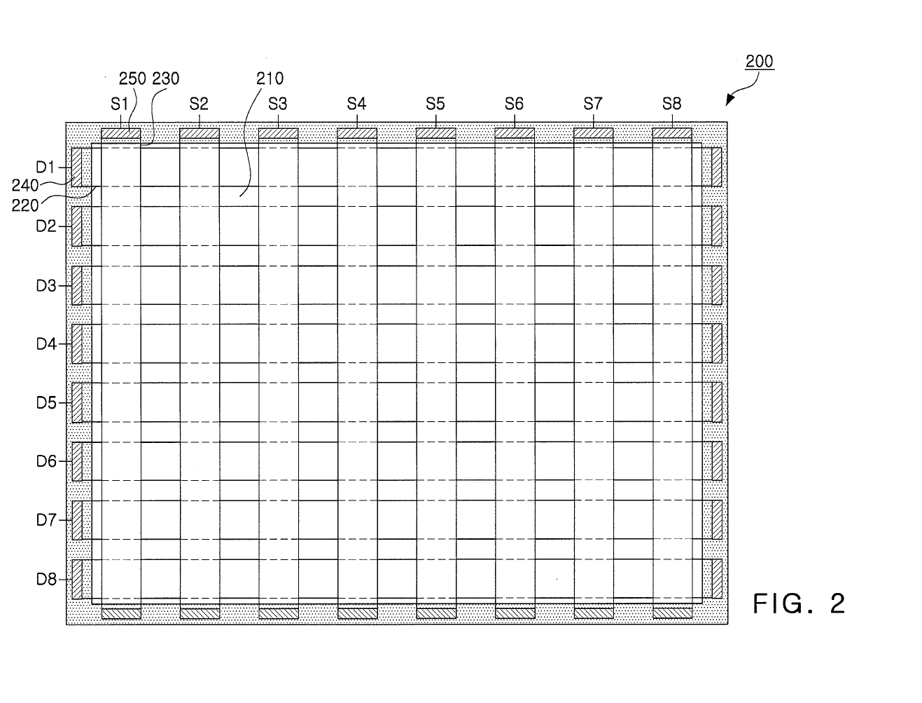

FIG. 2 is a view illustrating a touch panel applicable to a touchscreen apparatus according to an exemplary embodiment of the present disclosure.

Referring to FIG. 2, a touch panel 200 according to an exemplary embodiment of the present disclosure includes a substrate 210, a plurality of electrodes 220 and 230 provided on the substrate 210, and a plurality of pads 240 and 250 connected to the plurality of electrodes 220 and 230, respectively. Although not shown in FIG. 2, the plurality of pads 240 and 250 connected to the plurality of electrodes 220 and 230, respectively, may be electrically connected to a wiring pattern of a circuit board attached to one end of the substrate 210 through a wiring and a bonding pad. The circuit board may be mounted with a controller integrated circuit to detect sensing signals generated from the plurality of electrodes 220 and 230 and determine the touches from the detected sensing signals.

The substrate 210 may be transparent, for forming of the plurality of electrodes 220 and 230. Therefore, as described above, the substrate 210 may be formed of a film made of a material such as polyethylene terephtalate (PET), polycarbonate (PC), polyethersulfone (PES), polyimide (PI), polymethylmethacrylate (PMMA), cyclo-olefin polymers (COP), or the like, or a transparent substrate made of a material such as soda glass or tempered glass.

The plurality of electrodes 220 and 230 may include first electrodes 220 extended in an X axial direction and second electrodes 230 extended in a Y axial direction. The first electrodes 220 and the second electrodes 230 may be provided on both surfaces of the substrate 210 or be provided on different substrates to intersect each other. In the case in which both the first electrodes 220 and the second electrodes 230 are provided on one surface of the substrate 210, a predetermined insulating layer may be partially formed at points at which the first electrodes 220 and the second electrodes 230 intersect. Alternatively, the first electrodes 220 and the second electrodes 230 may be provided on different substrates to be disposed to intersect each other.

Further, a region of the substrate 210 in which the plurality of pads 240 and 250 are provided to be connected to the plurality of electrodes 220 and 230, respectively, except for a region thereof in which the plurality of electrodes 220 and 230 are formed, may be provided as a predetermined printed region for visually shielding the wirings generally formed of an opaque metal material.

The touch sensing apparatus electrically connected to the plurality of electrodes 220 and 230 to sense touches may detect changes in capacitance generated in the plurality of electrodes 220 and 230 by touches and sense the touches from the detected changes in capacitance. The first electrodes 220 may be connected to channels defined as D1 to D8 in the controller integrated circuit to thereby have a predetermined driving signal applied thereto, and the second electrodes 230 may be connected to channels defined as S1 to S8 to thereby be used for the touch sensing apparatus to detect a sensing signal. Here, the controller integrated circuit may detect a change in mutual capacitance generated between the first and second electrodes 220 and 230 to thereby obtain the sensing signal, and be operated in a manner in which the driving signal is sequentially applied to each of the first electrodes 220 while changes in capacitance in the second electrodes 230 are simultaneously detected.

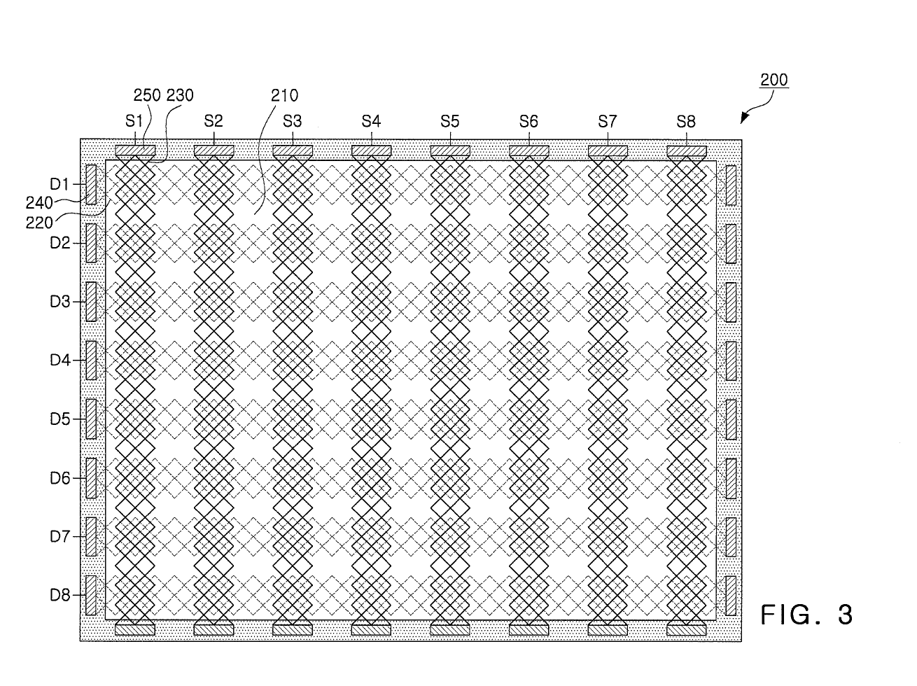

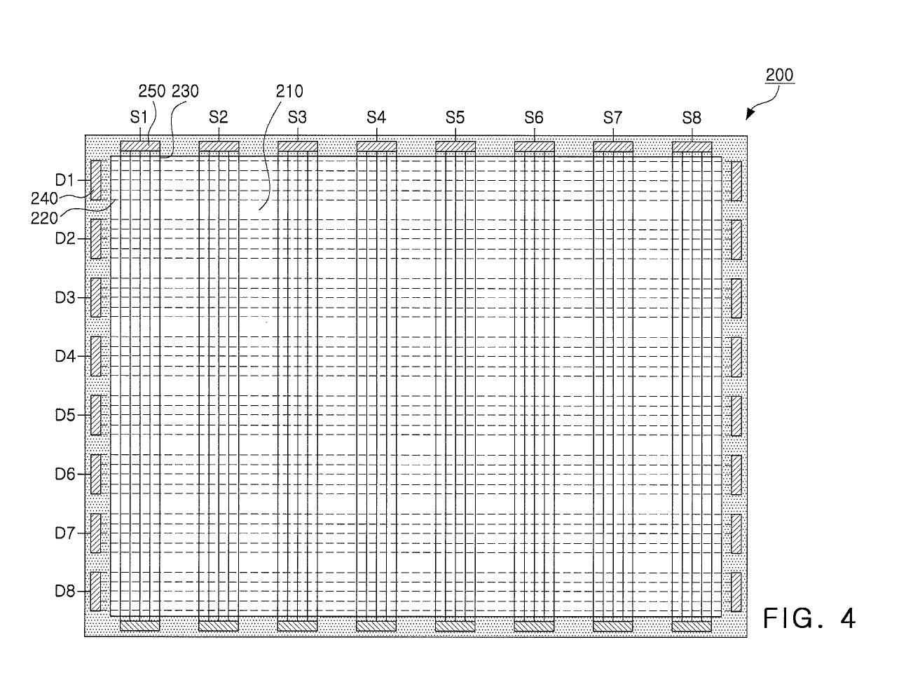

FIGS. 3 and 4 are views illustrating the touch panel according to the exemplary embodiment of FIG. 2 in more detail. Referring to FIG. 3, the plurality of electrodes 220 and 230 may include conductive lines, and the conductive lines configuring the plurality of electrodes 220 and 230 may be formed in a net or mesh pattern. By the conductive lines formed in the net or mesh pattern, a phenomenon in which a patterning mark has been seen in a region in which indium-tin oxide (ITO) electrodes exist may be decreased, and transparency of the touch panel may be improved.

Although FIG. 3 illustrates a case in which the conductive lines configuring the plurality of electrodes 220 and 230 are formed in a rhombus or rectangular pattern, the pattern of the conductive lines is not limited thereto, and the pattern of the conductive lines according to embodiments of the present disclosure may include a range readily apparent to, or able to be easily deducted by, those skilled in the art, such as a hexagonal pattern, an octagonal pattern, a diamond pattern, a random pattern, and the like, and may be formed in a linear manner as shown in FIG. 4.

The conductive lines configuring the plurality of electrodes 220 and 230 may be formed of any one of silver (Ag), aluminum (Al), chrome (Cr), nickel (Ni), molybdenum (Mo), and copper (Cu), or an alloy thereof. In the case in which the plurality of electrodes 220 and 230 are formed of the metal, a resistance value of the electrode may be decreased, such that conductivity and detection sensitivity may be improved.

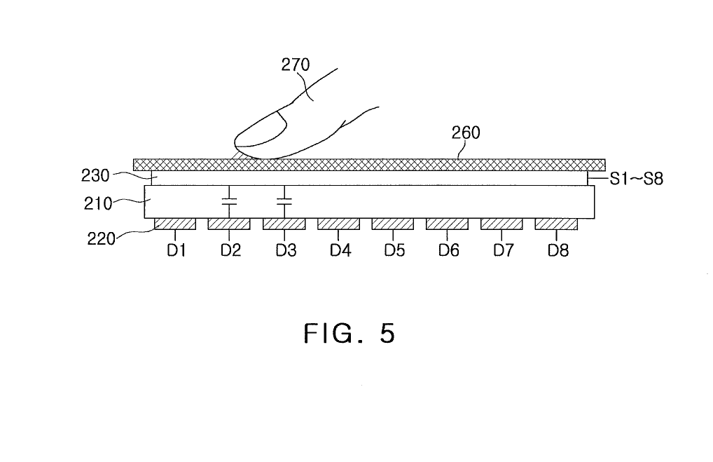

FIG. 5 is a cross-sectional view of the touch panel shown in FIGS. 2 through 4. The touch panel may further include a cover lens 260 to which touches are applied, in addition to the substrate 210, the plurality of electrodes 220 and 230, and the plurality of pads (not shown) as described in FIGS. 2 through 4. The cover lens 260 is provided on the second electrodes 230 used for detecting the sensing signal to receive the touches from an object 270 such as a finger, or the like.

In the case in which a driving signal is sequentially applied to the first electrodes 220 through channels D1 to D8, mutual capacitance may be generated between the first electrode 220 to which the driving signal is applied and the second electrode 230, and in the case in which the object approaches or contacts the cover lens 260, the mutual capacitance generated between the first electrode 220 and the second electrode 230 adjacent to a region touched by the object may be changed. The change in capacitance may be proportional to an area of an overlapped region between the object 270 and the first electrode 220 to which the driving signal is applied and the second electrode 230. In FIG. 5, the mutual capacitance generated between the first electrode 220 and the second electrode 230 connected to the channels D2 and D3 may be affected by the object 270.

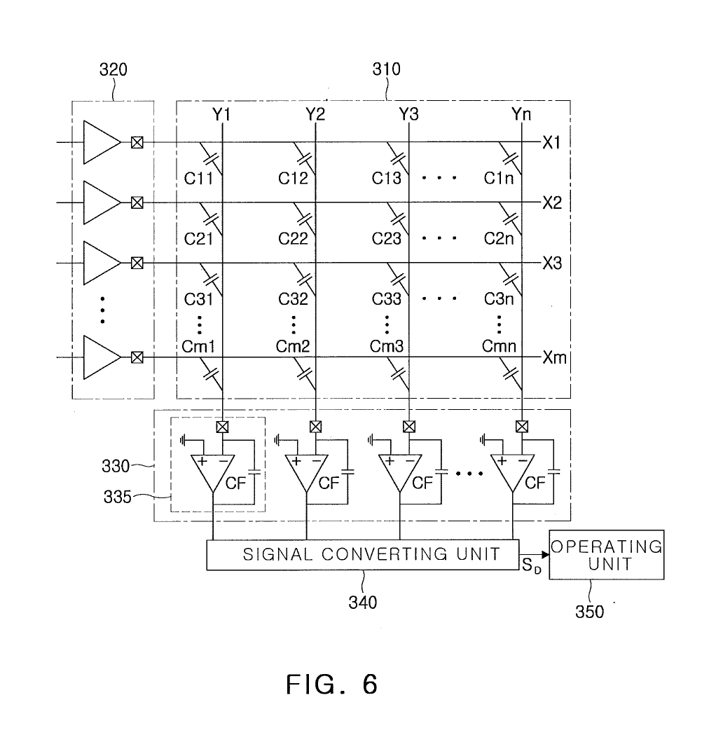

FIG. 6 is a view illustrating a touchscreen apparatus according to an exemplary embodiment of the present disclosure. Referring to FIG. 6, the touchscreen apparatus according to this exemplary embodiment of the present disclosure may include a panel unit 310, a driving circuit unit 320, a sensing circuit unit 330, a signal converting unit 340, and an operating unit 350. In this case, the driving circuit unit 320, the sensing circuit unit 330, the signal converting unit 340, and the operating unit 350 may be configured as a single integrated circuit (IC). The touchscreen apparatus according to this exemplary embodiment of the present disclosure may use the touch panel of FIGS. 2 through 5 as the panel unit 310.

The panel unit 310 may include a plurality of rows of first electrodes X1 to Xm extended in a first axial direction (that is, a horizontal direction of FIG. 6) and a plurality of columns of second electrodes Y1 to Yn extended in a second axial direction (that is, a vertical direction of FIG. 6) intersecting with the first axial direction. In this case, node capacitors C11 to Cmn correspond to the mutual capacitances generated at points at which the plurality of first electrodes X1 to Xm and the plurality of second electrodes Y1 to Yn intersect.

The driving circuit unit 320 may apply a predetermined driving signal to the plurality of first electrodes X1 to Xm of the panel unit 310. The driving signal may be a square wave signal, a sine wave signal, a triangle wave signal, or the like, having a predetermined period and amplitude and being sequentially applied to each of the plurality of first electrodes X1 to Xm. FIG. 6 illustrates that circuits for generating and applying the driving signal are individually connected to the plurality of first electrodes X1 to Xm; however, a single driving signal generating circuit may also generate a driving signal and apply the generated driving signal to each of the plurality of first electrodes X1 to Xm using a switching circuit. In addition, the driving circuit unit 320 may be operated in a scheme in which the driving signal is simultaneously applied to all of the first electrodes X1 to Xm or selectively applied only to some of the first electrodes X1 to Xm to simply sense the presence or absence of the touch.

The sensing circuit unit 330 may detect capacitances of the node capacitors C11 to Cmn from the plurality of second electrodes Y1 to Yn. The sensing circuit unit 330 may include a plurality of C-V converters 335 each including at least one operational amplifier and at least one capacitor, and the plurality of C-V converters 335 may be connected to the plurality of second electrodes Y1 to Yn, respectively.

The plurality of C-V converters 335 may convert the capacitances of the node capacitors C11 to Cmn into a voltage signal to thereby output an analog signal. As an example, each of the plurality of C-V converters 335 may include an integrating circuit integrating the capacitance. The integrating circuit may integrate the capacitance to convert the capacitance into a predetermined voltage and output the converted voltage.

FIG. 6 illustrates a configuration of the C-V converter 335 in which a capacitor CF is disposed between an inverting terminal and an output terminal of the operational amplifier; however, an arrangement of the circuit configuration may be changed. Further, FIG. 6 illustrates that the C-V converter 335 includes a single operational amplifier and a single capacitor; however, the C-V converter 335 may include a plurality of operational amplifiers and a plurality of capacitors.

In the case in which the driving signal is sequentially applied to the plurality of first electrodes X1 to Xm, since capacitance may be simultaneously detected from the plurality of second electrodes Y1 to Yn, the number of C-V converters 335 may correspond to the number (n) of the plurality of second electrodes Y1 to Yn.

The signal converting unit 340 may generate a digital signal S_{D} from an analog signal generated by the sensing circuit unit 330. As an example, the signal converting unit 340 may include a time-to-digital converter (TDC) circuit measuring a time required for a voltage type analog signal outputted from the sensing circuit unit 330 to reach a predetermined reference voltage level and converting the measured time into a digital signal S_{D}, or an analog-to-digital converter (ADC) circuit measuring a variation in a level of an analog signal outputted from the sensing circuit unit 330 for a predetermined time and converting the measured variation into a digital signal S_{D}.

The operating unit 350 may determine a touch applied to the panel unit 310 using the digital signal S_{D}. The operating unit 350 may determine the number, coordinates, gesture operations, or the like, of touches applied to the panel unit 310 using the digital signal S_{D}.

The digital signal S_{D} on which the operating unit 350 is based to determine the touch may be data obtained by digitizing the change in capacitances C11 to Cmn, and particularly, may be data representing a change in capacitance between a case in which the touch has not occurred and a case in which the touch has occurred. Generally, in a capacitive type touchscreen apparatus, it is seen that capacitance at a region contacted by a conductive object is decreased as compared to a region that is not contacted.

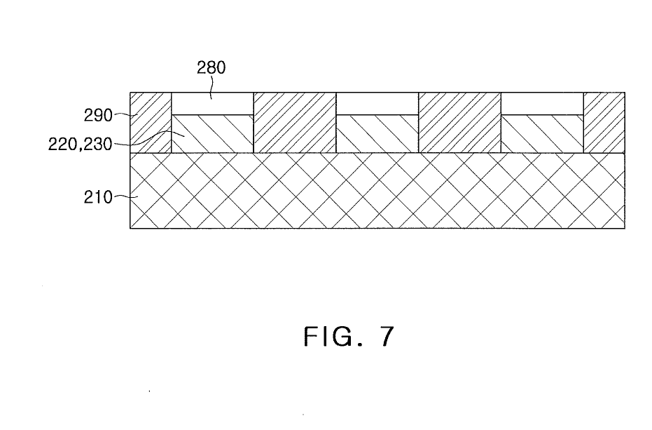

FIG. 7 is a view illustrating a cross-section of the touch panel according to an exemplary embodiment of the present disclosure. The touch panel according to an exemplary embodiment of the present disclosure may include a substrate 210, electrodes 220 and 230 including conductive lines of a mesh form, a first anti-reflective layer 280, and a second anti-reflective layer 290. FIG. 7 illustrates that the electrodes 220 and 230 are formed on one surface of the substrate; however, the electrodes 220 and 230 may be formed on both surfaces of the substrate and may be formed on different substrates.

Since details of the substrate 210 and the electrodes 220 and 230 are the same as the above description, they will be omitted and the first and second anti-reflective layers 280 and 290 will be described.

The first anti-reflective layer 280 may be formed on upper surfaces of the conductive lines configuring the electrodes 220 and 230, and the second anti-reflective layer 290 may be formed on regions of the substrate 210, that is, voids in which the conductive lines of the electrodes 220 and 230 are not formed. In this case, a sum of a thickness of the conductive line and a thickness of the first anti-reflective layer 280 may be equal to a thickness of the second anti-reflective layer 290.

Here, the first anti-reflective layer 280 may have a refractive index higher than that of the second anti-reflective layer 290, where the refractive index of the first anti-reflective layer 280 may be higher than 1.6 and the refractive index of the second reflective layer 290 may be equal to or lower than 1.6. The first and second anti-reflective layers 280 and 290 may be formed of a transparent resin having a photo-initiator added thereto. As an example, the first anti-reflective layer 280 may be formed of a photo resist to which the photo-initiator is added.

According to the exemplary embodiment of the present disclosure, an optical interference principle depending on the refractive indices of the first and second anti-reflective layers 280 and 290 may decrease a difference in reflectivity between regions in which the conductive lines are formed and are not formed. In addition, the first anti-reflective layer 280 is formed on the upper surfaces of the conductive lines and the second anti-reflective layer 290 is formed at sides of the conductive lines, such that corrosion of the conductive lines may be prevented, whereby corrosion resistance of the touch panel may be reinforced.

A process of manufacturing a touch panel according to an exemplary embodiment of the present disclosure will be described. A predetermined metal film may be formed on one surface or both surfaces of the substrate 210 using a vacuum deposition method such as a sputtering process, an E-beam process, or the like, an electrolytic method such as a plating process, or processes such as a printing process, an imprinting process, and the like. Next, a photo resist having a photo-initiator added thereto is coated on an upper surface of the metal film, a predetermined region of the coated photo resist is exposed and developed to thereby form a mask pattern, and the metal film is etched using the mask pattern, thereby forming the electrodes 220 and 230 formed of conductive lines and the first anti-reflective layer 280. The first anti-reflective layer 280 is not formed by providing a transparent resin having a predetermined refractive index on the conductive line, but is formed by adding the photo-initiator to the photo resist naturally used in a photo lithography process, such that the manufacturing process may be simplified.

Next, the transparent resin to which the photo-initiator is added may be printed on the voids of the substrate 210 using a screen printing method, thereby forming the second anti-reflective layer 290.

As set forth above, according to exemplary embodiments of the present disclosure, the anti-reflective layers having different refractive indices are formed on the conductive lines provided on the substrate and the voids of the substrate, such that the conductive lines of the electrodes may not be apparently visible and corrosion resistance of the conductive lines may be reinforced.

While exemplary embodiments have been shown and described above, it will be apparent to those skilled in the art that modifications and variations could be made without departing from the spirit and scope of the present disclosure as defined by the appended claims.

What is claimed is:

1. A touch panel, comprising:
a substrate;
a plurality of electrodes formed on an upper surface of the substrate and including conductive lines having a mesh form; and
anti-reflective layers formed on upper surfaces of the conductive lines and voids of the substrate,
wherein the anti-reflective layer formed on the upper surfaces of the conductive lines has a refractive index different from that of the anti-reflective layer formed on the voids of the substrate.

2. The touch panel of claim 1, wherein the anti-reflective layers include:
a first anti-reflective layer formed on the upper surfaces of the conductive lines; and
a second anti-reflective layer formed on the voids of the substrate.

3. The touch panel of claim 2, wherein a refractive index of the first anti-reflective layer is higher than 1.6, and
a refractive index of the second anti-reflective layer is equal to or lower than 1.6.

4. The touch panel of claim 2, wherein a sum of a thickness of the conductive line and a thickness of the first anti-reflective layer is equal to a thickness of the second anti-reflective layer.

5. The touch panel of claim 1, wherein the anti-reflective layers are formed of a transparent resin having a predetermined photo-initiator added thereto.

6. The touch panel of claim 2, wherein the first anti-reflective layer is formed of a photo resist having a predetermined photo-initiator added thereto.

7. The touch panel of claim 1, wherein the conductive lines are formed of anyone of silver (Ag), aluminum (Al), chrome (Cr), nickel (Ni), molybdenum (Mo), and copper (Cu) or an alloy of at least two of silver (Ag), aluminum (Al), chrome (Cr), nickel (Ni), molybdenum (Mo), and copper (Cu).

8. A method of manufacturing a touch panel, the method comprising:
forming a metal film on one surface of a substrate;
coating a photo resist having a photo-initiator added thereto on the metal film;
forming a mask pattern by removing a predetermined region of the photo resist;
forming conductive lines having a mesh form by etching the metal film using the mask pattern; and
printing a transparent resin having a photo-initiator added thereto on voids of the substrate.

9. The method of claim 8, wherein the photo resist has a refractive index higher than 1.6, and
an anti-reflective layer formed of the transparent resin has a refractive index equal to or lower than 1.6.

10. The method of claim 8, wherein the metal film is formed of any one of silver (Ag), aluminum (Al), chrome (Cr), nickel (Ni), molybdenum (Mo), and copper (Cu) or an alloy of at least two of silver (Ag), aluminum (Al), chrome (Cr), nickel (Ni), molybdenum (Mo), and copper (Cu).

11. The method of claim 8, wherein the transparent resin is printed by a screen printing process.

12. A touchscreen apparatus, comprising:
a panel unit including a substrate, a plurality of electrodes formed on an upper surface of the substrate and including conductive lines having a mesh form, and anti-reflective layers formed on upper surfaces of the conductive lines and voids of the substrate; and
a controlling unit determining a touch by applying a predetermined driving signal to a portion of the plurality of electrodes and detecting capacitance from the remaining electrodes among the plurality of electrodes,
wherein the anti-reflective layer formed on the upper surfaces of the conductive lines has a refractive index different from that of the anti-reflective layer formed on the voids of the substrate.
